(19) United States
(12) Patent Application Publication
(10) Pub. No.: US 2025/0199570 A1
(43) Pub. Date: Jun. 19, 2025

(54) HINGE LOCK APPARATUS FOR ELECTRONIC DEVICES AND RELATED METHODS

(71) Applicant: Intel Corporation, Santa Clara, CA (US)

(72) Inventors: Kasthuri Rangan Vijayasarathy, Bangalore (IN); Smit Kapila, Bengaluru (IN); Samarth Alva, Bangalore (IN); Jayprakash Thakur, Bangalore (IN); Jeff Ku, Taipei (TW)

(21) Appl. No.: 18/542,178

(22) Filed: Dec. 15, 2023

(51) Int. Cl. G06F 1/16

(52) U.S. Cl. CPC G06F 1/1616

(57) ABSTRACT

Hinge lock apparatus for electronic devices and related methods are disclosed. A system includes a first housing, a second housing, and a hinge to pivotally couple the first housing and the second housing. The hinge includes a hinge lock apparatus having a lock interface and an actuator movable relative to the lock interface between a first position to engage the lock interface to at least one of prevent or restrict rotation of the first housing relative to the second housing, and a second position to disengage the lock interface to enable rotation of the first housing relative to the second housing. Processor circuitry operates the actuator based on a detected condition of the first housing relative to the second housing.

### FIELD OF THE DISCLOSURE

This disclosure relates generally to electronic devices and, more particularly, to hinge lock apparatus for electronic devices and related methods.

### BACKGROUND

In recent years, electronic devices have been manufactured with screens, keyboards, and hinges that connect the screen to the keyboard.

### BRIEF DESCRIPTION OF THE DRAWINGS

FIG. 1 is an example electronic device including an example hinge lock apparatus in accordance with teachings of this disclosure.

FIG. 2A is a partial, perspective view of the example hinge lock apparatus of the example electronic device of FIG. 1.

FIG. 2B is a perspective view of an example actuator of the example hinge lock apparatus of FIG. 2A.

FIG. 3 is a partial, perspective view of the example hinge lock apparatus of the example electronic device of FIG. 1 in an example released or deactivated condition.

FIG. 4 is a partial, perspective view of the example hinge lock apparatus of the example electronic device of FIG. 1 in an example engaged or activated condition.

FIG. 5 is another example electronic device disclosed herein that can be implemented with an example hinge lock apparatus disclosed herein.

FIG. 6 is yet another example electronic device disclosed herein that can be implemented with an example hinge lock apparatus disclosed herein.

FIG. 7 is a block diagram of an example implementation of an example hinge management circuitry that can implement example hinge lock apparatus disclosed herein.

FIGS. 8-9 are flowcharts representative of example machine readable instructions and/or example operations that may be executed, instantiated, and/or performed by example programmable circuitry to implement the example hinge management circuitry of FIG. 7.

FIG. 10 is a block diagram of an example processing platform including programmable circuitry structured to execute, instantiate, and/or perform the example machine readable instructions and/or perform the example operations of FIGS. 8-9 to implement the hinge management circuitry of FIG. 7.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 8-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Displays of electronic devices are susceptible to damage. One of the causes of display damage can stem from object(s) (e.g., a pen, a micro-drive, an eraser, audio, or headphone wire, etc.) lying on a cover (e.g., c-cover) during a lid closure event. Another cause can occur during hard or forceful lid closures (e.g., slamming or lid banging). Often, such causes of damage to displays are often omitted from warranty policies.

Examples disclosed herein include a hinge lock apparatus or assembly for electronic devices that protects a display from damage and/or improves thermal efficiency or performance during certain device operations. In some instances, example hinge lock mechanisms disclosed herein reduce or prevent display damage due to objects positioned on or over an upper surface of a housing (e.g., C-cover). For example, electronic devices disclosed herein can employ ultrasound spatial awareness systems (e.g., using speakers and microphones of the device) to detect objects positioned on the housing (e.g., a c-cover) and deploy example hinge lock apparatus disclosed herein to prevent damage to a display when an object is detected. As an alternative to ultrasound spatial awareness solution, other existing sensors (e.g., Compute Vision or TOF (time of flight) or UWB sensor or any other Radar sensors (e.g., 60 GHz sensor used for infrared sensing)) available in a computing or electronic device (generally placed in a lid) can be used for object detection on housing (e.g., a C-cover).

In another example, example hinge lock apparatus disclosed herein can protect a display from damage during high force and/or hard closures of the lid (e.g., lid banging). For instance, example hinge lock apparatus disclosed herein help prevent or reduce instances of screen damage due to high force closure (e.g., banging of a lid on the base when closing the laptop). In some examples, example hinge lock apparatus disclosed herein can be configured to activate when an angle of the display relative to the base (e.g., keyboard) decreases beyond certain speed, in which processor circuitry of a computing device and/or electronic device can determine (e.g., interpret) a high force lid closure event can be imminent.

Additionally, hinge lock apparatus disclosed herein can be used to fix an angular position of a display relative to a base (e.g., keyboard) a certain angle (e.g., 15 degrees) for thermal purposes. During high-performance mode, users often close a lid of a computing device (e.g., laptop) and employ (e.g., connect the laptop to) an external display (e.g., for game play). In the closed position during high-performance mode, thermal system or efficiency may be affected because the closed lid blocks or obstructs vents (e.g., positioned on a C cover or keyboard). Example hinge lock apparatus disclosed herein enable users to select a high-performance mode (e.g., via an OEM software) to fix a position or an opening angle (e.g., between approximately 15 degrees and 20 degrees) to allow heat to vent. The lid would be forced to stop at this angle, and the external display would not be blocked by the laptop lid since the opening angle is low.

In some examples, hinge lock apparatus disclosed herein can be activated to lock a position of a touch screen to increase stability to enable user interaction with the touch screen without resulting in the screen moving when engaged by a user performing a touch event. Example hinge lock mechanisms disclosed herein do not impact chassis size (e.g. z-direction or thickness) and does not result in added costs to the product.

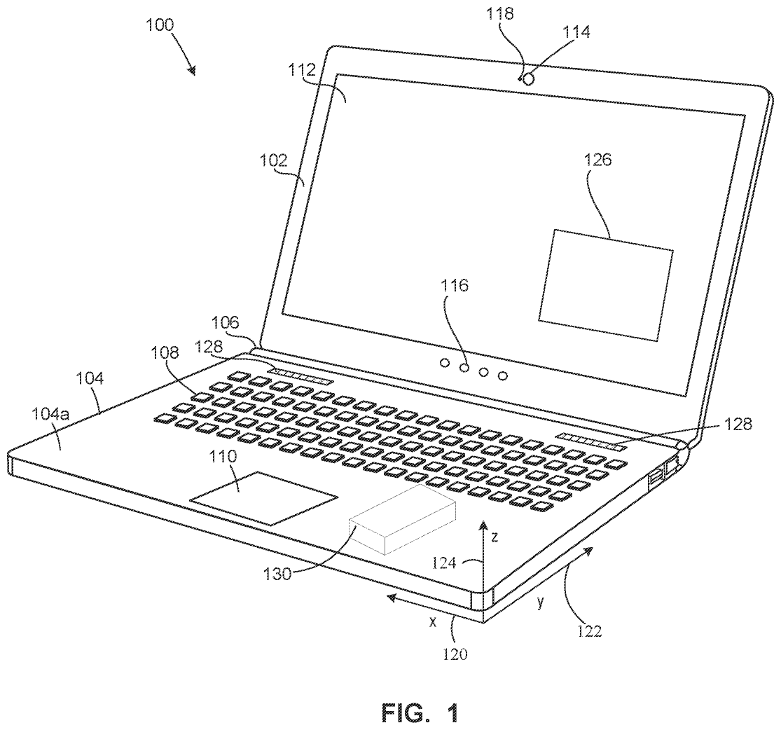

FIG. 1 is an example electronic device 100 constructed in accordance with teachings of this disclosure. The electronic device 100 of the illustrated example is a personal computing device such as, for example, a laptop. The electronic device 100 of the illustrated example includes a first housing 102 (e.g., a lid, a screen, display, touchscreen etc.) coupled to a second housing 104 (e.g., a base, a keyboard, c-cover) via a hinge 106. The hinge 106 enables the first housing 102 to rotate or fold relative to the second housing 104 between a closed or stored position (e.g., where the second housing 104 is aligned or parallel with the first housing 102) and an open position as shown in FIG. 1 (e.g., where the second housing 104 is non-parallel relative to the first housing 102). In the open position, the second housing 104 can rotate relative to the first housing 102 about the hinge 106 to a desired viewing angle.

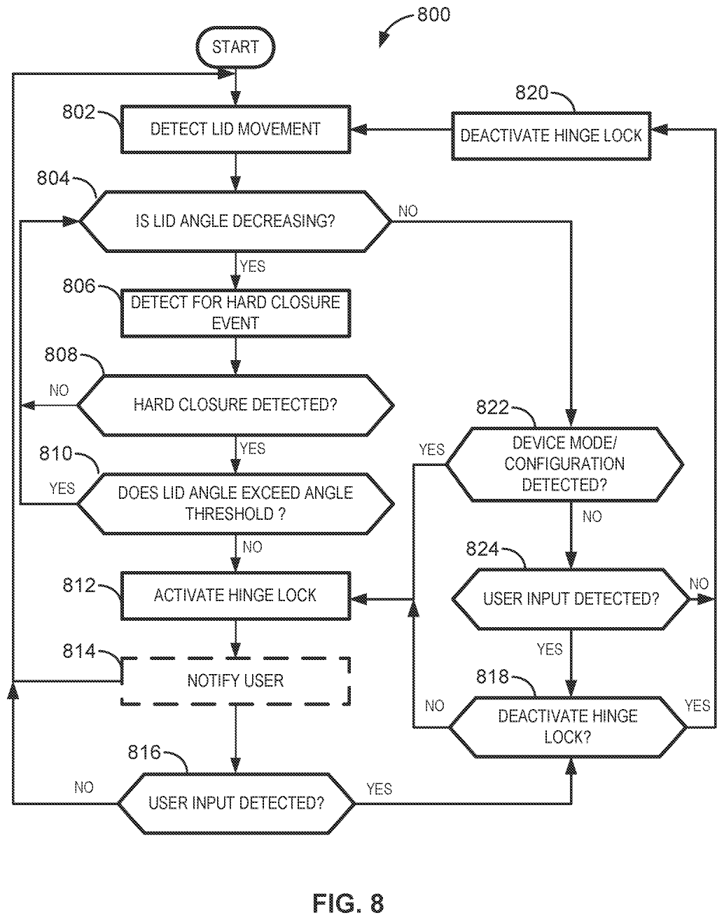

To enable user inputs, the second housing 104 of the illustrated example includes a keyboard 108 and a track pad 110. For example, the keyboard 108 and the track pad 110 are exposed at an upper surface 104a of the second housing 104 (e.g., opposite a bottom surface). The first housing 102 carries a display 112, a camera 114, speakers 116, and a microphone 118. In some examples, the display 112 is a touch screen. The example speakers 116 may transmit ultrasound waves that are detectable by the example microphone 118. The ultrasound waves may be used by example object detection circuitry 706 (FIG. 7) to detect objects on the surface of the second housing 104. The display 112 of the illustrated example presents a graphic user interface (GUI) to enable a user to interact with the electronic device 100 (e.g., to select and/or adjust setting of the electronic device 100 via the keyboard 108, the track pad 110 and/or touch feature of the display 112).

The second housing 104 houses electronic components (e.g., I/O connectors, a graphics card, a battery, light emitting diodes, memory, a storage drive, an antenna, etc.) of the electronic device 100 and hardware components (e.g., cooling fans, a central processing unit (CPU) coupled to a circuit board that executes software to interpret and output response(s) based on the user input event(s) (e.g., touch event(s), keyboard input(s), etc.)). The second housing 104 has a width in an x-direction 120, a length in a y-direction 122, and a height in a z-direction 124 (e.g., a depth in a z-direction). References to the x-y-z direction throughout this specification pertain a direction along the width in the x-direction 120, the length in the y-direction 122, and the height in the z-direction 124, respectively.

The electronic device 100 of the illustrated example employs the hinge 106 (e.g., a smart hinge) to restrict and/or prevent rotation of the first housing 102 relative to the second housing 104 based on a detected condition or operating mode of the electronic device 100. For example, the hinge 106 disclosed herein can be employed to prevent or reduce damage to a display when the first housing 102 moves to the closed position. For example, the electronic device 100 can employ processor circuitry to detect if a closing speed (e.g., a closing velocity) or closing force of the first housing 102 relative to the second housing 104 exceeds a threshold closing speed representative of an impact of the first housing 102 into the second housing 104 that would likely cause damage to (e.g., crack) the display 112.

Additionally, the upper surface 104a provides a surface area surrounding the keyboard 108 and/or the track pad 110. However, in some instances, an example object 130 (e.g., an eraser, a pencil, a headphone wire, etc.) can be placed or temporarily located on the upper surface 104a of the second housing 104. However, moving the first housing 102 to the closed position while the object 130 is present on the upper surface 104a can cause damage to (e.g., crack a screen of) the display 112 of the first housing 102. Some example processor circuitry disclosed herein can employ the hinge 106 to prevent or restrict rotation of the first housing 102 relative to the second housing 104 based on a detected presence of an object 130 on the upper surface 104a of the second housing 104 when the first housing 102 is moving toward the closed position. Thus, the examples disclosed herein advantageously reduce a likelihood of damage to a display of an electronic device.

Some example processor circuitry disclosed herein can detect the electronic device 100 operating in the high-performance mode (e.g., a processor power greater than 20 watts). The high-performance mode can include, for example, game mode, video editing mode, presentation mode, artificial intelligence inference mode, etc. The example high-performance mode allows cooling fans to activate to remove excess heat through one or more example vents 128. However, if the first housing 102 is in the closed or stored position (e.g., during a high-performance mode operation), the first housing 102 can impede or restrict airflow through the vents 128, which can restrict removal of excess heat from the vents 128. Example processing circuitry disclosed herein can employ the hinge 106 to restrict or prevent a closing event between of the first housing 102 and the second housing 104 to prevent the first housing 102 from restricting or impeding heat dissipation or air flow through the example vents 128. For example, in a high-performance mode, the first housing 102 can only rotate about the hinge 106 to an angular position relative to the second housing 104 that is greater than an angle threshold (e.g., 5 degrees from the closed position). The hinge 106 prevents rotation of the first housing 102 relative to the second housing 104 along angular positions that do not exceed the angle threshold (e.g., angular positions less than 5 degrees from the closed position). Thus, the examples disclosed herein advantageously reduce a likelihood of restricting excess heat flow from the vents 128 when the electronic device 100 is in a high-performance mode operation.

In some examples, processor circuitry determines a configuration of the electronic device 100 and prevents or restricts rotation of the first housing 102 based on the detected configuration (e.g., to provide stability to the electronic device 100 and/or stability for touch display use). For example, the hinge 106 can be structured to enable the electronic device 100 of FIG. 1 to be configured in different use positions. For example, the hinge 106 can be structured to enable the electronic device 100 to be configured in a tent configuration, a kiosk configuration, a tablet mode, and/or any other configuration. For example, in the tablet mode, the first housing 102 is rotated approximately 360 degrees from the closed position such that the first housing 102 is positioned on the second housing 104 with the display 112 exposed for user use. In the kiosk mode, the first housing 102 is rotated to a viewing angle of greater than 180 degrees relative to the upper surface 104a of the second housing 104, and the keyboard 108 can engage and/or be adjacent a support surface (e.g., a table or desk) or a user's lap. In the tent mode, the first housing 102 is rotated relative to the second housing 104 to an angle that is greater than 270 degrees from the closed position such that respective edges of the second housing 104 and the first housing 102 can engage a support surface (e.g., a table or desk). In some examples, with the first housing 102 locked from rotating about the hinge 106, the first housing 102 can be used as a touch display without causing the first housing 104 to rotate when touched or engaged by a user.

In some examples, processor circuitry disclosed herein can prevent, restrict, or allow rotation of the first housing 102 based on an example hinge lock mode 126 provided by a user input (e.g., a touch event imparted to the display 112). For example, the electronic device 100 receives one or more user commands (e.g., via the display 112, the keyboard 108, the track pad 110, voice command, etc.) to indicate that the electronic device is in the high-performance mode, the tent configuration, the kiosk configuration, the tablet configuration and/or any other operating mode and/or configuration. In other words, in some examples, the electronic device 100 receives one or more user input signals from the hinge lock mode 126 (e.g., activated or selected by a user via the keyboard 108, track pad 110, the display 112, voice command, etc.) to activate the hinge lock mode 126. In some examples, processor circuitry can receive instructions to deactivate a hinge lock mode 126 based on a user input.

Although the example electronic device 100 of the illustrated example is a laptop, in some examples, the electronic device 100 can be a foldable tablet (e.g., having a two housings), a desktop computer, a mobile device, a cell phone, a smart phone, a hybrid or convertible PC, a personal computing (PC) device, a server, a modular compute device, a digital picture frame, a graphic calculator, a smart watch, and/or any other electronic device that has a hinge 106 that pivotally connects a first housing and a second housing.

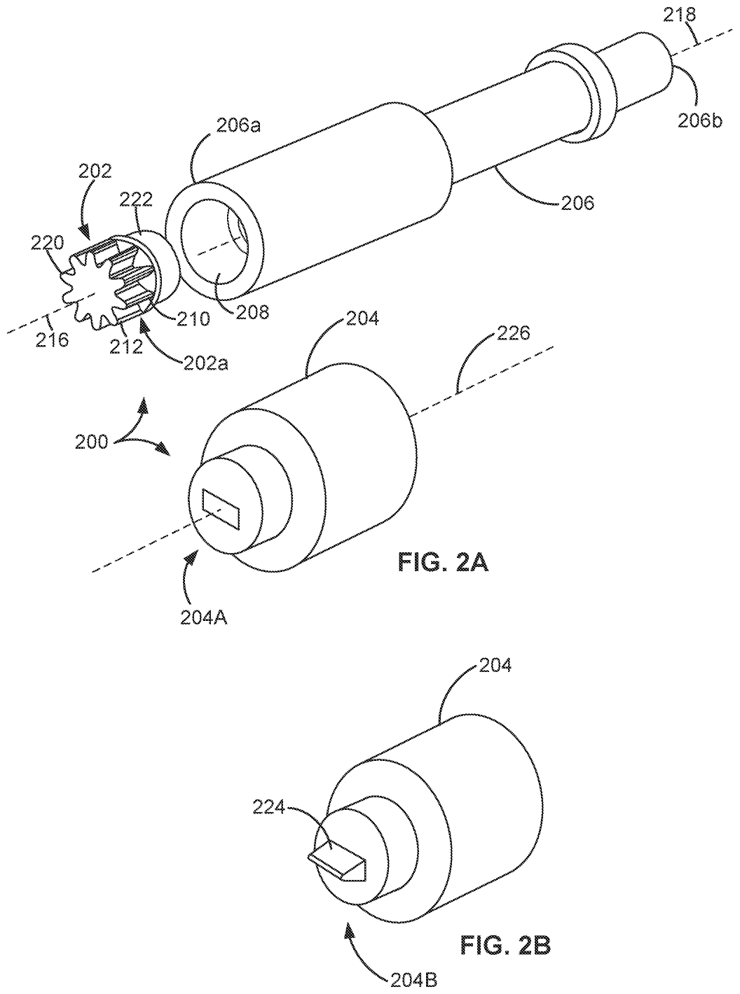

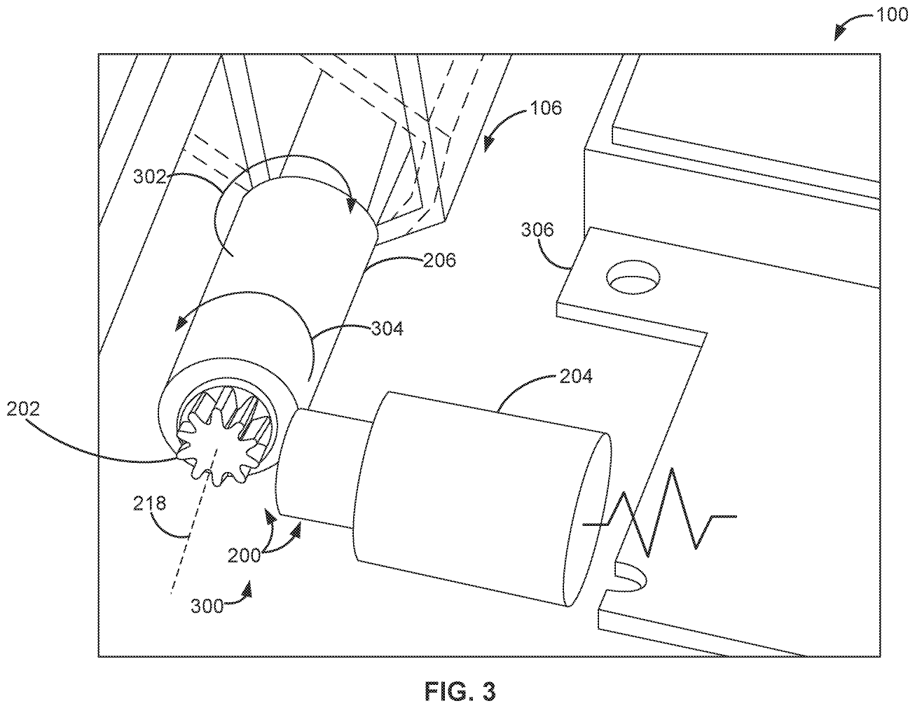

FIG. 2A is a perspective, partial view of the example hinge 106 of the example electronic device 100 of FIG. 1. The hinge 106 of the illustrated example includes a hinge lock apparatus 200 (e.g., a hinge lock assembly) disclosed herein. The hinge lock apparatus 200 of the illustrated example includes an example lock interface 202 (e.g., an actuator interface) and an example actuator 204. FIG. 2A illustrates the example actuator 204 in an example first or retracted position 204A (e.g., a non-activated position). FIG. 2B is a perspective view of the actuator 204 in an example second or extended position 204B (e.g., an activated position).

Referring to FIGS. 2A and 2B, the lock interface 202 of the illustrated example is coupled (e.g., fixed or attached) to a shaft 206 of the hinge 106. In some examples, the hinge 106 can include a second hinge lock apparatus (e.g., substantially similar or identical to the hinge lock apparatus 200) at a second end 206b of the shaft 206 opposite the first end 206a. To this end, the hinge 106 can include dual hinge lock apparatus. In some such examples, the dual hinge lock apparatus operates in unison.

The lock interface 202 of the illustrated example rotates with the shaft 206. For example, the lock interface 202 is fixed to the shaft 206. A first end 206a of the shaft 206 of the illustrated has an opening 208 to receive the lock interface 202. The opening 208 of the shaft 206 of the illustrated example includes internal threads and the lock interface 202 includes external threads for threadably coupling with the internal threads of the shaft 206.

The lock interface 202 of the illustrated example has a receptacle 202a (e.g., a slot, a recess, a window, a cavity, an opening, etc.) for interfacing with the actuator 204. The receptacle 202a of the lock interface 202 of the illustrated example includes a first protrusion 210 (e.g., first tooth, a first wall, etc.) and a second protrusion 212 (e.g., second tooth, a second wall, etc.), where a gap between the first protrusion 210 and the second protrusion 212 provides the receptacle 202a (e.g., a recess or opening). Additionally, an example longitudinal axis 216 of the lock interface 202 (e.g., the gear 220) coaxially aligns with an example longitudinal axis 218 of the example shaft 206. In some examples, the longitudinal axis 216 of the lock interface 202 can be canted, non-parallel, and/or offset relative to the longitudinal axis 218 of the shaft 206.

In the illustrated example, the lock interface 202 includes a gear 220 (e.g., a spur gear). Thus, the lock interface 202 of the illustrated example includes a plurality of projections (e.g., teeth) defining a plurality of receptacles 202a about a circumference of the gear 220. Providing a plurality of receptacles 202a enables the actuator 204 to interface with the lock interface 202 over a greater number of angular orientations or rotational positions of the first housing 102 relative to the second housing 104. The gear 220 of the illustrated example includes a barrel or body 222, where the body 222 includes the external threads for mounting the gear 220 and the shaft 206. In some examples, the external threads of the barrel 222 threadably couple with the internal threads of the shaft 206. In some examples, the shaft 206 and the lock interface 202 (e.g., the gear) can be integrally formed as a unitary body or monolithic structure (e.g., via injection molding, three-dimensional printing, etc.). In some examples, the body 222 can be press-fit with the opening 208 of the shaft 206. In some examples, the lock interface 202 and/or the shaft 206 can alternatively include a single receptacle 202a. In some examples, in lieu of the gear 220, the shaft 206 (e.g., an end of the shaft 206) can include one or more slots or apertures formed about a circumference or outer surface (e.g., adjacent the first end 206a) of the shaft 206 that can interact with (e.g., be engaged by) the actuator 204. In other examples, the example receptacle 202a may be a cavity, a latch, and/or any other locking means.

Referring to FIGS. 2A and 2B, the actuator 204 includes an example actuator plunger 224 (e.g., a head, a pin, a projection, a protrusion, an extension, a wedge, a tongue, a tip, a body, etc.) that is moveable or extendable between the retracted position 204A and the extended position 204B (e.g., to interact with the lock interface 202). The actuator 204 of the illustrated example can be an electromagnetic plunger, a solenoid, a stepper motor, and/or any other actuator that can interface with the lock interface 202.

The actuator plunger 224 of the illustrated example interacts with the lock interface 202 (e.g., the receptacle 202a of the lock interface 202). For instance, the actuator plunger 224 engages or extends (e.g., fits) into the receptacle 202a of the lock interface 202 to prevent or restrict rotation of the first housing 102 relative to the second housing 104 and retracts from the receptacle 202a to allow rotation of the first housing 102 relative to the second housing 104. The actuator plunger 224 of the illustrated example has a tapered or angled profile or shape. In some examples, the actuator plunger 224 has a shape that is complementary to a shape of the receptacle 202a and/or protrusions 210, 212 (e.g., the teeth of the gear 220). As a result, the actuator plunger 224 is to enmesh or interlock with the gear teeth of the gear 220 when the actuator plunger 224 is in the extended position 204B. Additionally, the actuator 204 of the illustrated example is oriented toward the lock interface 202. For example, the actuator 204 has a longitudinal axis 226 that is non-parallel (e.g., perpendicular) relative to the longitudinal axis 216 of the lock interface 202. The non-parallel relationship between the actuator 204 and the lock interface 202 enables the actuator plunger 224 to contact (e.g., matably engage) the receptacle 202a. For example, the actuator plunger 224 matably engages with the protrusions 210, 212 when the actuator plunger 224 extends into the receptable 202a. The actuator plunger 224, when extended into engagement with one or more of the protrusions 210, 212, provides an interference (e.g., an obstruction or frictional interference) with the protrusions 210, 212 to prevent or restrict rotation of the gear 220 and, thus, the shaft 206 about a rotational axis (e.g., the longitudinal axis 218) of the hinge 106.

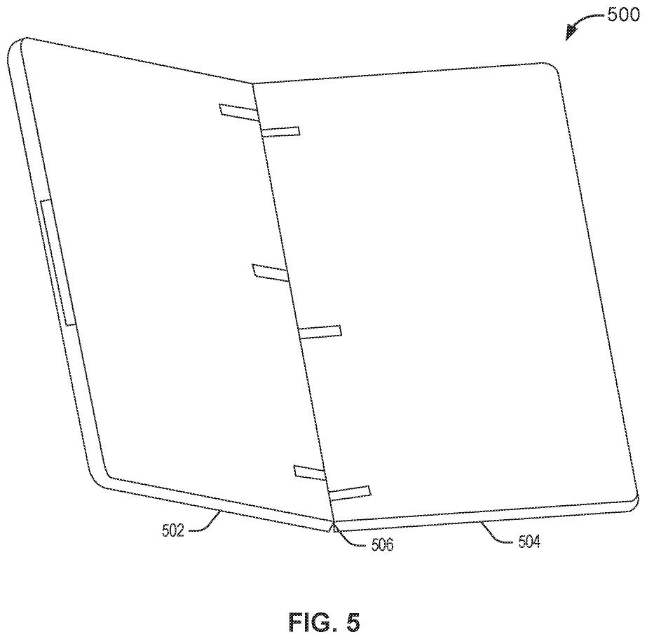

The lock interface 202 (e.g., the gear 220, the protrusions 210, 212, etc.) and/or the actuator plunger 224 of the illustrated example can include, or be composed of, a rigid material. For example, providing the lock interface 202 and/or the actuator plunger 224 that includes a rigid material can prevent (e.g., stop) rotation of the first housing 102 relative to the second housing 104 about the hinge 106 when the hinge lock apparatus 200 is in the activated condition 400 (FIG. 4) (e.g., when the actuator plunger 224 is in the receptacle 202a and engages the protrusions 210 and/or 212). A rigid material(s) includes, for example, metal injection molding materials (e.g., MIM), stainless steel (e.g., 17-4PH, 316L, 310, 420, 440, etc.), and low alloy steel (2200, 2700, 4140, 4340, 4605, 8620, 52100) and/or other material(s) that can prevent (e.g., lock) rotation of the hinge 106 (FIG. 1) when the hinge lock apparatus 200 is in the activated condition 400 (FIG. 4).

The lock interface 202 (e.g., the gear 220, the protrusions 210, 212, etc.) and/or the actuator plunger 224 of the illustrated example can include (e.g., be composed of) a semi-flexible material and/or a flexible material. For example, providing the lock interface 202 and/or the actuator plunger 224 with a semi-flexible and/or a flexible material can restrict (e.g., interfere or impede), but not prevent, rotation of the hinge 106 to reduce a closing force or speed of rotation of the first housing 102 relative to the second housing 104 when the actuator 204 is in the activated condition 400. For instance, if the lock interface 202 (e.g., the gear 220) includes a semi-flexible or flexible material, the protrusions 210 and/or 212 (e.g., the teeth of the gear 220) can deflect, bend and/or otherwise elastically deform (e.g., in a downwardly or upwardly direction) the hinge 106 rotates about the longitudinal axis 218. For instance, if the actuator plunger 224 is composed of a semi-flexible or flexible material, the actuator plunger 224 can deflect, bend or otherwise elastically deform (e.g., downwardly or upwardly). Employing a semi-flexible or flexible material can increase friction between the lock interface 202 and the actuator plunger 224 to reduce a force or speed of rotation of the first housing 102 when rotating toward the closed position. In some examples, a semi-rigid or semi-flexible material includes, for example, hard rubber and/or any other material(s)) that add resistance to the hinge movement without fully locking or without preventing rotation of the hinge 106 (FIG. 1).

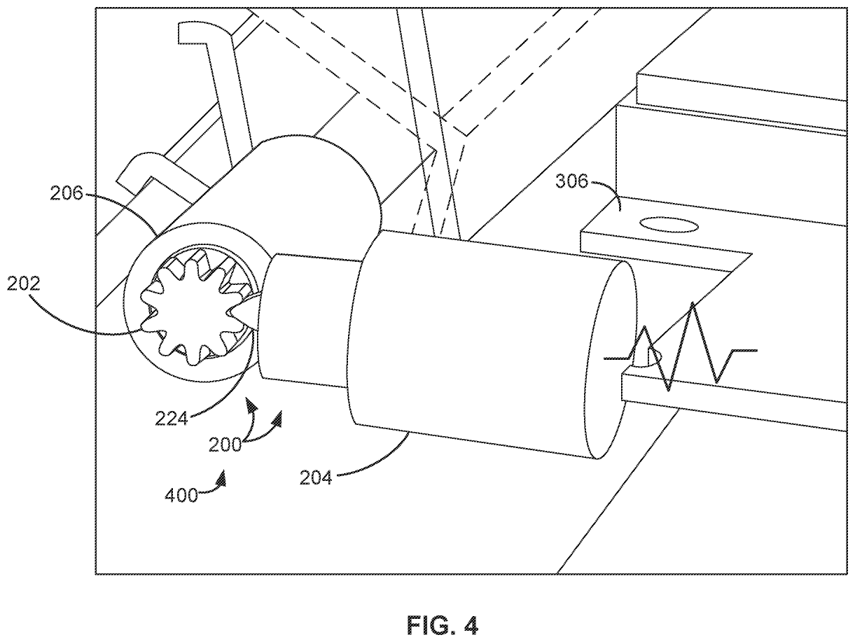

FIG. 3 is a partial, perspective view of the electronic device 100 of FIG. 1 with example hinge lock apparatus 200 in an example released or unlocked position 300 (e.g., a deactivated condition, unlocked condition). In the released position 300, the hinge lock apparatus 200 enables the hinge 106 (e.g., the shaft 206) to rotate freely about the longitudinal axis 218 in a first rotational direction 302 (e.g., a clockwise direction in the orientation of FIG. 3) and a second rotational direction 304 (e.g., a counterclockwise direction in the orientation of FIG. 3). In other words, in the released position 300, the actuator plunger 224 is in the retracted position 204A (FIG. 2A) and is disengaged or removed from (e.g., is not in engagement with) the lock interface 202 (e.g., the protrusions 210 and/or 212, the gear 220, etc.). The actuator 204 of the illustrated example is electrically and/or communicatively coupled (e.g., connected) to an example circuit board 306. The circuit board 306 includes a processor or processor circuitry that can operate the actuator 204 based on one or more detected conditions of the electronic device 100. For example, the processor circuitry can generate control signals (e.g., electromagnetic signals) to control the actuator 204 between the retracted position 204A (FIG. 2A) and the extended position 204B (FIG. 2B). In some examples, a user input (e.g., long key press) can generate a control signal (e.g., an electromagnetic signal) to control the state of the actuator 204 between the retracted position 204A (FIG. 2A) and the extended position 204B (FIG. 2B) and, thus, the state of the hinge lock apparatus 200.

FIG. 4 is a partial perspective view of the example hinge lock apparatus 200 of the example electronic device 100 of FIG. 1 in an activated condition 400. In the example activated condition 400, the example actuator plunger 224 is in the extended position 204B (FIG. 2B) and positioned in the receptacle 202a (FIG. 2A) to engage (e.g., directly contact) the first protrusion 210 (FIG. 2A) and/or the second protrusion 212 (FIG. 2A). Such engagement restricts or prevents rotation of the first housing 102 (FIG. 2A) relative to the second housing 104 (FIG. 2A) about the longitudinal axis 218 (FIG. 2A) of the hinge 106 (FIG. 2A).

In some examples, the actuator 204 is omitted and a post or beam projects to engage the lock interface 202. In other words, the post engages the gear 220 at all times during rotation of the first housing 102 relative to the second housing 104. In some such examples, the post restricts rotational speed or movement of the first housing 102 relative to the second housing 104.

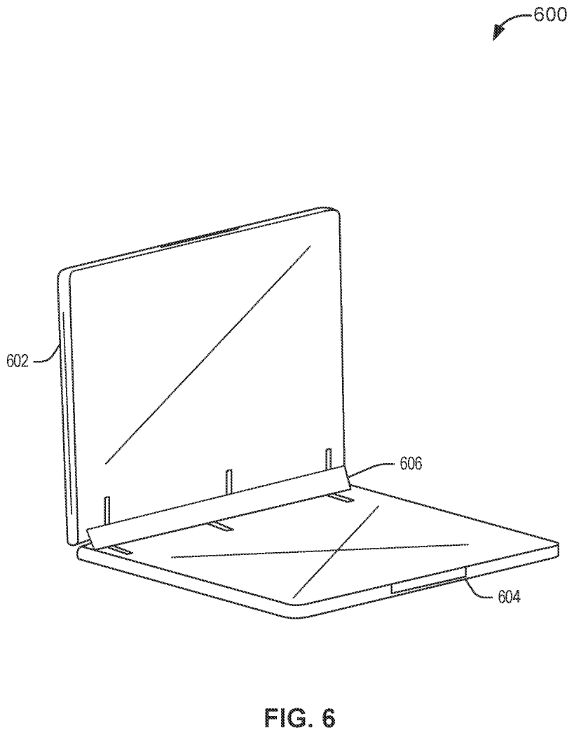

FIG. 5 is another example electronic device 500 that can be implemented with an example hinge lock apparatus disclosed herein. The example electronic device 500 includes a left surface 502 (e.g., first touch screen surface) and a right surface 504 (e.g., second touch screen surface) that are connected by an example hinge 506. The example electronic device 500 has the example hinge 506 in a vertical position (e.g., in a vertical alignment). In some examples, the electronic device 500 is a foldable smartphone.

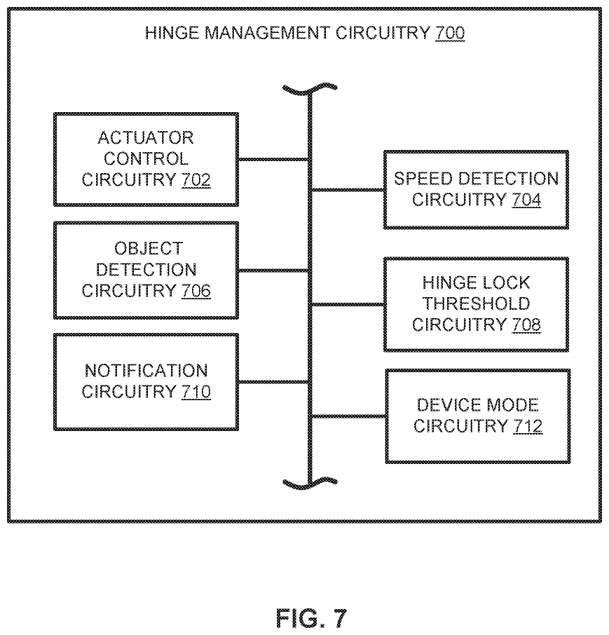

FIG. 6 is yet another example electronic device 600 that can be implemented with an example hinge lock apparatus disclosed herein. The example electronic device 600 includes a top surface 602 (e.g., first touch screen surface) and a bottom surface 604 (e.g., second touch screen surface) that are connected by an example hinge 606. The example electronic device 600 has the example hinge 606 in a horizontal position (e.g., in a horizontal alignment). In some examples, the electronic device 600 is a foldable smartphone.

FIG. 7 is a block diagram of an example implementation of an example hinge management circuitry 700 that can implement example hinge lock apparatus disclosed herein (e.g., the hinge lock apparatus 200). The example hinge management circuitry 700 may implement the example electronic devices 100, 500, 600 of FIGS. 1, 5, and/or 6. The hinge management circuitry 700 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the hinge management circuitry 700 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

The example hinge management circuitry 700 includes an example actuator control circuitry 702, example speed detection circuitry 704, example object detection circuitry 706, example hinge lock threshold circuitry 708, example notification circuitry 710, and example device mode circuitry 712. In some examples, the example actuator control circuitry 702, the example speed detection circuitry 704, the example object detection circuitry 706, the example hinge lock threshold circuitry 708, example notification circuitry 710, and the example device mode circuitry 712 are in communication (e.g., via a communication bus, by writing and reading data from a memory, etc.).

The example actuator control circuitry 702 operates (e.g., activates or deactivates) the example actuator 204 (FIG. 2A) between a first operating condition (e.g., the retracted position 204A) and a second operating condition (e.g., the extended position 204B). For example, to control operation of the actuator 204, the actuator control circuitry 702 of the illustrated example sends one or more instructions and/or commands (e.g., electrical signals, binary signals, analog signals, current, etc.) to the actuator 204 to cause the actuator 204 to move between the extended position 204B to engage the lock interface 202 and/or the receptacle 202a (FIG. 2A) to restrict rotation of the first housing 102 (FIG. 1) relative to the second housing 104 (FIG. 1) or the retracted position 204A to enable rotation of the first housing 102 (FIG. 1) relative to the second housing 104 (FIG. 1). The example actuator control circuitry 702 may activate the actuator 204 based on one or more detected conditions determined by one or more of the example speed detection circuitry 704, the example object detection circuitry 706, and/or the example device mode circuitry 712.

The speed detection circuitry 704 determines if the detected velocity and/or force imparted to the first housing 102 can cause potential damage (e.g., a cracking risk) to the display 112 (FIG. 1) when the first housing 102 (FIG. 1) rotates about the hinge 106 toward the second housing 104. To determine the speed and rotational direction (e.g., velocity) of the first housing 102 relative to the second housing 104 and/or a force imparted to the first housing 102, the speed detection circuitry 704 of the illustrated example determines a rate of reduction of a lid angle (e.g., an angle between the first housing 102 and the second housing 104) as the first housing 102 moves toward the second housing 104 to the closed position. To detect a rate of reduction of the lid angle, the speed detection circuitry 704 receives one or more feedback signals or information from, for example, an accelerometer, a gyroscope, a rotary encoder, and/or any other suitable component(s) or velocity measuring means of the electronic device 100 that can measure or detect a velocity and/or force of the first housing 102 (e.g., a closing speed or closing velocity, a detected closing speed). For example, the speed detection circuitry 704 receives one or more feedback signals from a rotary encoder to determine a direction in which the first housing 102 is rotating relative to the second housing 104 (e.g., by comparing successive angles). In some examples, the speed detection circuitry 704 employs an application programming interface (API) to provide an angular position of the first housing 102 relative to the second housing 104. For example, if successive angles are decreasing, the speed detection circuitry 704 determines that the direction of the first housing 102 is moving toward the second housing 104. If successive angles are increasing, the speed detection circuitry 704 determines that the direction of the first housing 102 is moving away from the second housing 104. Additionally, comparing a rate of successive angular positions of the first housing 102 relative to the second housing 104, the speed detection circuitry 704 can determine a speed or velocity of the first housing 102.

In some examples, the example speed detection circuitry 704 analyzes the received feedback signals to estimate or determine if a closing force imparted to the first housing 102 (e.g., by a user) when the first housing 102 moves toward the closed position exceeds a force threshold for potential risk of damage. For example, the speed detection circuitry 704 can calculate an acceleration of the first housing 102 based on the detected speed and retrieve or obtain a mass value from memory or a look-up table of the first housing 102. The speed detection circuitry 704 communicates the detected or measured speed or force value to the hinge lock threshold circuitry 708.

To determine if the speed and/or force can cause potential damage to the first housing 102, the hinge lock threshold circuitry 708 compares a speed value and/or force value to a hinge lock threshold. For example, the hinge lock threshold circuitry 708 obtains or retrieves a speed threshold value or a force threshold value from memory or a look-up table. The speed threshold or force threshold values are indicative of speed or force values that can cause potential damage (e.g., cracking risk) to the display 112 (FIG. 1) of the first housing 102 (FIG. 1) (e.g., a user slamming the first housing 102 (FIG. 1) into the second housing 104 (FIG. 1)). If the detected speed exceeds the speed threshold and/or the detected force exceeds the force threshold, the hinge lock threshold circuitry 708 commands or instructs the example actuator control circuitry 702 to activate the actuator 204 to reduce a closing rate of the first housing 102 and/or prevent further rotation of the first housing 102 (e.g., a rate of lid closing). For example, if the hinge lock threshold circuitry 708 determines that the detected speed and/or detected force provided by the speed detection circuitry 704 exceeds the speed threshold and/or force threshold, the hinge lock threshold circuitry 708 can provide a first signal (e.g., a binary value “1”) to the actuator control circuitry 702 to cause the actuator 204 to move to the extended position 204B and, thus, cause activation of the hinge lock apparatus 200. If the hinge lock threshold circuitry 708 determines that the detected speed and/or detected force provided by the speed detection circuitry 704 does not exceed the speed threshold and/or force threshold, the hinge lock threshold circuitry 708 can provide a second signal (e.g., a binary value “0”) to the actuator control circuitry 702 to cause the actuator 204 to move to the retracted position 204B and, thus, cause deactivation of the hinge lock apparatus 200.

Equation 1 is an example equation that can be employed by the speed detection circuitry 704 and/or the hinge lock threshold circuitry 708.

HLT (hinge lock threshold)=f{rate of reduction of lid angle} Eq:1

In equation 1, the hinge lock apparatus 200 can be activated by the actuator control circuitry 702 when the speed detection circuitry 704 determines that a closing speed or rate of reduction of the lid angle is greater than the HLT. The HLT provides a value representative of a speed that can be deemed too excessive or too high and can cause a risk for damage (e.g., a banging risk).

The example object detection circuitry 706 determines a presence or an absence of an object (e.g., the object 130 of FIG. 1) on the upper surface 104a of the second housing 104 during a closing event (e.g., when the first housing 102 is moving toward the second housing 104 about the hinge 106). For example, the object detection circuitry 706 can communicate with the speed detection circuitry 704 to determine a lid angle and/or a closing event. In some examples, the object detection circuitry 706 can determine a lid rate of reduction similar to the speed detection circuitry 704 to determine that the first housing 102 is moving toward the second housing 104 (e.g., a closing event). For example, to detect a rate of reduction of the lid angle, the object detection circuitry 706 receives one or more feedback signals or information from, for example, an accelerometer, a gyroscope, a rotary encoder, and/or any other suitable component(s) or velocity measuring means of the electronic device 100 that can measure or detect a velocity and/or force of the first housing 102 (e.g., a detected closing speed). For example, the object detection circuitry 706 receives one or more feedback signals from a rotary encoder to determine a direction in which the first housing 102 is rotating relative to the second housing 104 (e.g., by comparing a pattern of successive angles).

In response to detecting a closing event, the object detection circuitry 706 of the illustrated example detects or monitors for a presence of an object. To detect a presence or absence of an object on the upper surface 104a of the second housing 104 during a closing event, the object detection circuitry 706 of the illustrated example analyzes one or more feedback signals obtained using one or more techniques including, but not limited to, sonar, ultrasound sensor, time of flight sensor, ultrawide band frequency and/or radio frequency.

To detect the presence or absence of an object on the upper surface 104a of the second housing 104, the object detection circuitry 706 of the illustrated example imparts vibration to the electronic device 100 (e.g., the second housing 104) via the speakers 116 (FIG. 1) and receives an ultrasound signal (e.g., a sound wave or frequency) generated by the speakers 116 via the microphone 118 (FIG. 1). In turn, the object detection circuitry 706 analyzes the ultrasound signal (e.g., a sound wave or frequency) based on the ultrasound waves that are received by the example microphone 118 to determine if an object is present or absent on the upper surface 104a when the first housing 102 is moving or rotating toward the closed position. For example, a presence of an object on the upper surface 104a results in a first sound wave (e.g. frequency) pattern and an absence of an object on the upper surface 104a results in a second sound wave (e.g., frequency) pattern. For example, the object detection circuitry 706 can employ an ultrasound sensor and/or can compare (e.g., via the hinge lock threshold circuitry 708) the sound wave (e.g., an electrical signal representative of the sound wave converted by the microphone 118) to one or more values (e.g., stored a look-up table) to determine the presence or absence of an object (e.g., the object 130) on the upper surface of the second housing 104.

In some examples, the object detection circuitry 706 determines an object location (e.g., object position), an object size, and/or an object height of a detected object. For example, the object detection circuitry 706 can determine if the object 130 (FIG. 1) is adjacent to the vents 128 (FIG. 1) or the track pad 110 (e.g., an object location). For example, if the object detection circuitry 706 detects that the object 130 is adjacent the vents 128, the object detection circuitry 706 can allow rotation of the first housing 102 along a first range of lid angles (e.g., between 70 degrees and 180 degrees in the open position). Alternatively, if the object detection circuitry 706 determines that the example object 130 (FIG. 1) is adjacent the track pad 110 (FIG. 1), the object detection circuitry 706 can allow rotation of the first housing 102 along a second range of lid angles (e.g., between 30 degrees and 180 degrees in the open position) that is greater than the first range of lid angles. The example object detection circuitry 706 determines the allowable angles of rotation associated with the object 130 (FIG. 1) being adjacent to the vents 128 (FIG. 1) is different than the allowable angles of rotation associated with the object 130 (FIG. 1) being adjacent the track pad 110 (FIG. 1). The example object detection circuitry 706 allows angles that are unlikely to crack the display 112 (FIG. 1) based on the position and/or location of the object 130 (FIG. 1).

In some examples, the object detection circuitry 706 determines a height of the object 130 in the z-direction 124 (FIG. 1). To this end, the object detection circuitry 706 can allow rotation of the first housing 102 relative to the second housing 104 along a third range of lid angles (e.g., 60 degrees to 180 degrees) if the detected or measured height of the object 130 exceeds a height threshold (e.g., three inches) or a fourth range of lid angles (e.g., 30 degrees to 180 degrees) if the detected or measured height of the object 130 does not exceed a height threshold (e.g., three inches).

The example hinge lock threshold circuitry 708 compares the values measured and calculated by the example object detection circuitry 706 and commands the actuator control circuitry 702 based on the compared values. For example, the hinge lock threshold circuitry 708 can provide a first signal (e.g., a binary signal “1”) to the actuator control circuitry 702 when the object detection circuitry 706 detects the presence of an object and a second signal (e.g., a binary signal “0”) to the actuator control circuitry 702 when the object detection circuitry 706 detects an absence of an object on the upper surface 104a of the second housing 104. In some examples, the hinge lock threshold circuitry 708 may compare an actual lid angle (e.g., a current lid angle, a present lid angle, etc.) with a threshold lid angle (e.g., target lid angle) based on a detected position, an estimated size and/or height of an object present on the upper surface 104a and commands the actuator control circuitry based on allowable rotational ranges (e.g., the first rotational range of lid angles, the second rotational range of lid angles, the third rotational range of lid angles, the fourth rotational range of lid angles) determined by the object detection circuitry 706.

Equation 2 is an example equation that can be employed by the object detection circuitry 706 and/or the hinge lock threshold circuitry 708.

HLT(hinge lock threshold)=f{lid angle, object size, object position} Eq:2

In equation 2, the hinge lock apparatus 200 can be activated by the actuator control circuitry 702 when the object detection circuitry 706 and/or the hinge lock threshold circuitry 708 (e.g., HLT) determines that an object is present on the upper surface 104a and/or the lid angle does not exceed an allowable range of lid angles based on a detected size, height and/or position the HLT.

The example notification circuitry 710 notifies a user of the electronic device 100 (FIG. 1) that the actuator 204 has been activated and that rotational movement of first housing 102 about the hinge 106 (FIG. 1) is restricted or prevented. By notifying a user, the example notification circuitry 710 may prevent the user from attempting to close the first housing 102 (FIG. 1) into the second housing 104 (FIG. 1) when the hinge lock apparatus 200 is in the activated condition 400. In some examples, the example notification circuitry 710 can display a popup image on the display 112 (FIG. 1). In some examples, the notification circuitry 710 employs an auditory alert to notify the user. In some examples, the example notification circuitry 710 may display a warning (e.g., audible and/or visual warning or alarm) that an object 130 (FIG. 1) is on the second housing 104 (FIG. 1) and/or that further movement or rotation of the first housing 102 (FIG. 1) toward the closed position can cause potential damage the display 112 (FIG. 1).

The example device mode circuitry 712 detects a device mode or device configuration. For example, the device mode circuitry 712 detects if the electronic device 100 is in a high-performance mode, a game mode, a tent configuration, a kiosk configuration, a tablet configuration, and/or any other suitable device mode or operation. For example, when a certain device mode or device configuration is detected by the device mode circuitry 712, the device mode circuitry 712 instructs or commands the actuator control circuitry 702 to operate (e.g., activate or deactivate) the actuator 204. In some examples, to determine a device mode and/or device configuration, the device mode circuitry 712 receives a signal input provided by a user via the display 112 (e.g., a touch event), the keyboard 108, the track pad 110, a voice command, and/or any other input device. In some examples, to detect a high-performance mode or game mode application, the device mode circuitry 712 receives feedback signals from a temperature sensor or a system application that indicates power consumption of a processor. For example, the device mode circuitry 712 detects a high-performance mode when a processor exceeds a power threshold (e.g., greater than 20 watts). Additionally, the device mode circuitry 712 can detect a lid angle similar to the speed detection circuitry 704 and/or the object detection circuitry 706. For example, the device mode circuitry 712 receives feedback signals from one or more sensors (e.g., a position sensor, a rotary encoder, a gyroscope, an accelerometer) and/or any other component(s) or sensor(s) of the electronic device 100.

For example, a user may desire boosted performance (e.g., during a game mode), which can cause a processor to generate more heat than when operating in a low-power mode. The excess heat is expelled through the example vents 128 (FIG. 1). When the electronic device 100 is in a high-performance mode, the example device mode circuitry 712 instructs the example actuator control circuitry 702 to activate the actuator 204 to lock the position of the first housing 102 (e.g., activate the hinge lock apparatus 200) when a lid angle of the first housing 102 does not exceed a lid angle threshold to ensure that the vents 128 remain unobstructed during a high performance mode. For example, the device mode circuitry 712 provides a range of acceptable lid angles that allow heat to escape from the example vents 128 (FIG. 1) and instructs or commands the example actuator control circuitry 702 to enable rotation of the first housing 102 (FIG. 1) in the range of acceptable lid angles (e.g., between 5 degrees and 180 degrees in the open position) and prevent rotation of the first housing 102 when the rotational angle of the first housing 102 relative to the second housing 104 does not exceed an angle threshold (e.g., 5 degrees from closed position).

In some examples, the device mode circuitry 712 causes activation of the hinge lock apparatus 200 when detecting the electronic device 100 in various configurations including for example, a tent configuration, a kiosk configuration, a tablet configuration, etc. In some examples, the device mode circuitry 712 employs an application programming interface (API) to provide an angular position of the first housing 102 relative to the second housing 104. In some examples, the device mode circuitry 712 receives feedback from one or more sensors to detect an angular position of the first housing 102 relative to the second housing 104. In some examples, the device mode circuitry 712 receives one or more input signals from a user to activate the hinge lock apparatus 200. The device mode circuitry 712 commands and/or instructs the actuator control circuitry 702 to activate the hinge lock apparatus 200 and lock a rotational position of the first housing 102 when the electronic device 100 is in the tent configuration, the kiosk configuration, the tablet configuration and/or any other configuration.

In the illustrated example, when hinge management circuitry 700 no longer detects a condition of the electronic device 100 that causes activation of the hinge lock apparatus 200 and/or receives a user input to deactivate the hinge lock apparatus 200, the hinge management circuitry 700 (e.g., the actuator control circuitry 702) causes the actuator 204 to move to the retracted position 204A to deactivate the hinge lock apparatus 200 and enable rotation of the first housing 102 relative to the second housing 104.

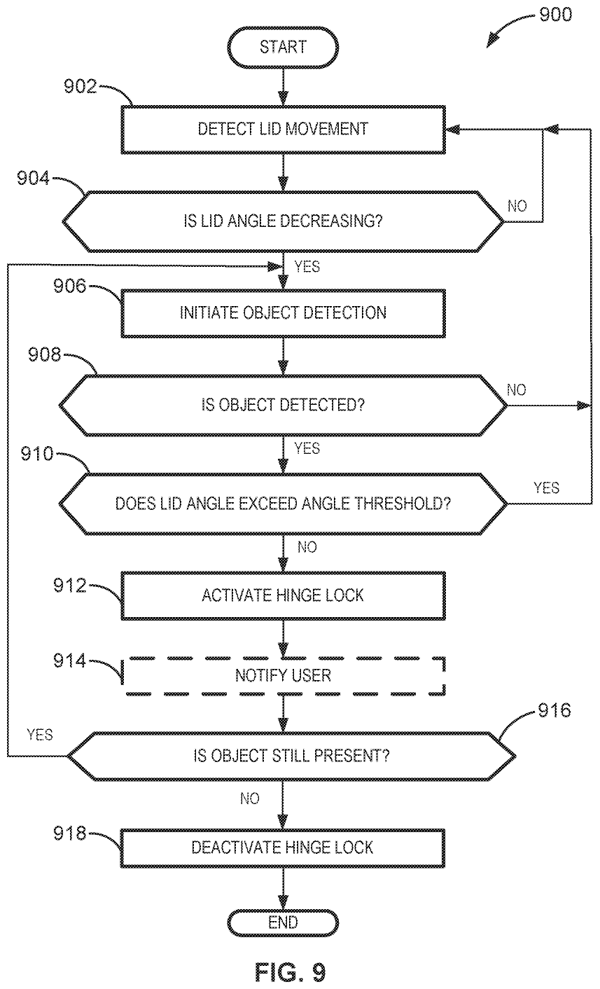

In some examples, the actuator control circuitry 702 is instantiated by programmable circuitry executing actuator control instructions and/or configured to perform operations such as those represented by the flowcharts of FIGS. 8-9.

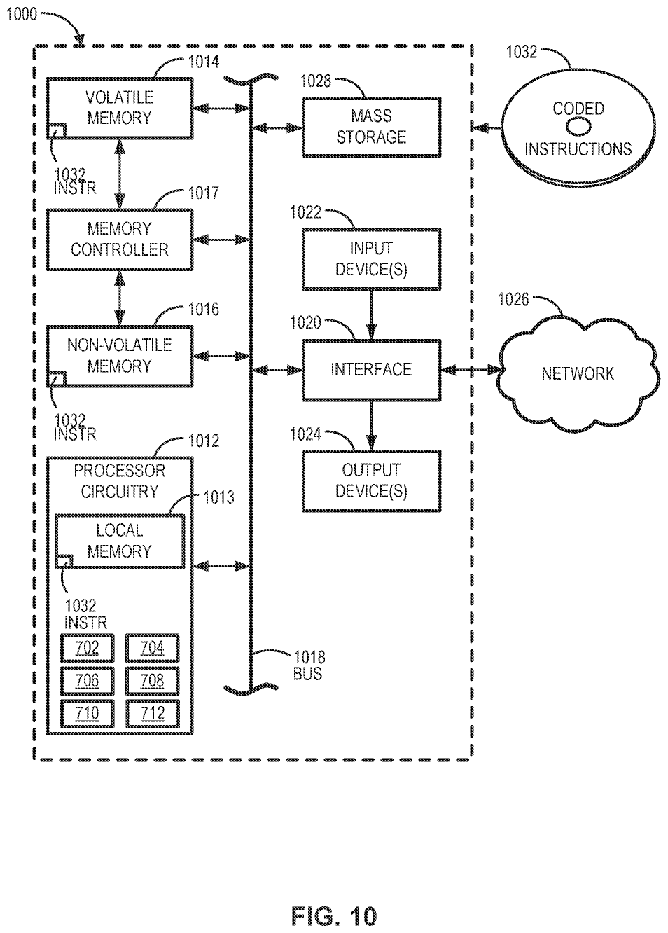

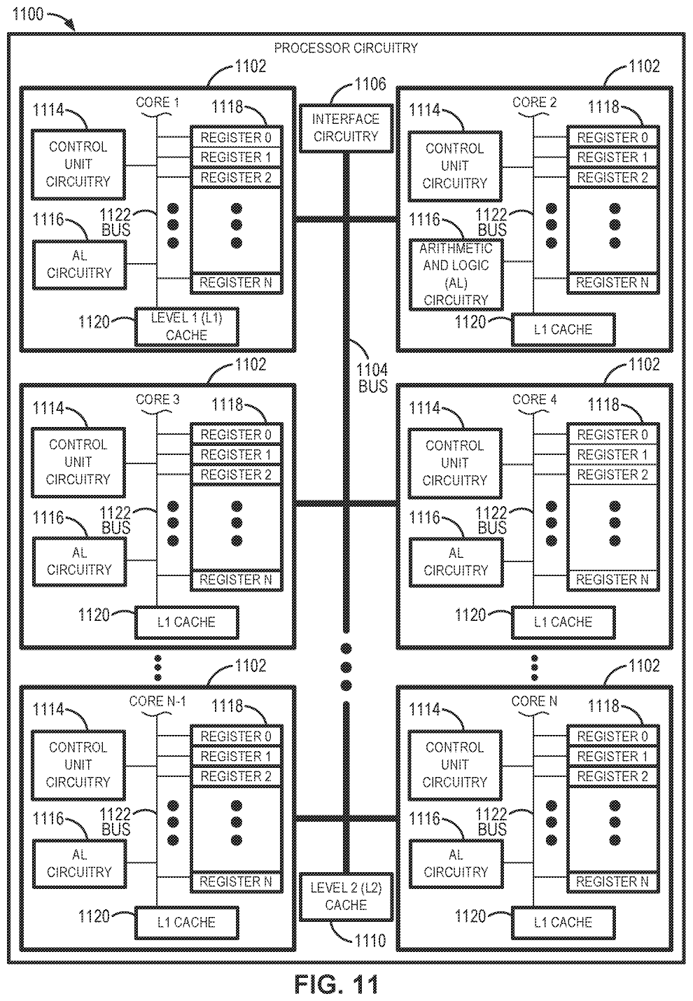

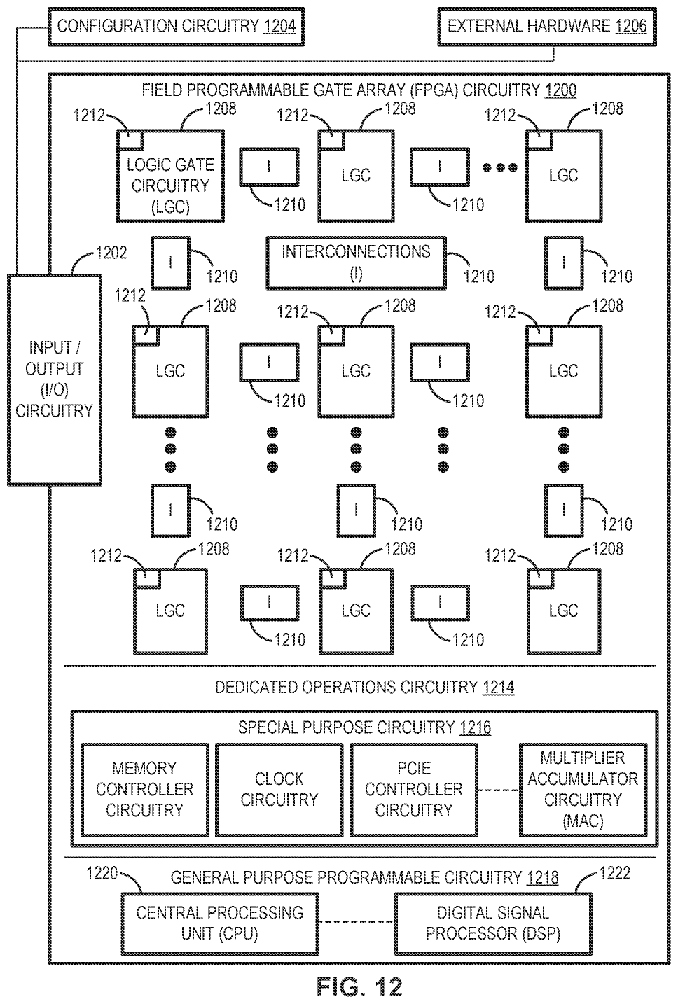

In some examples, the hinge management circuitry 700 includes means for activating a hinge lock. For example, the means for activating a hinge lock may be implemented by actuator control circuitry 702. In some examples, the actuator control circuitry 702 may be instantiated by programmable circuitry such as the example programmable circuitry 1012 of FIG. 10. For instance, the actuator control circuitry 702 may be instantiated by the example microprocessor 1100 of FIG. 11 executing machine executable instructions such as those implemented by at least blocks 812 and 820 of FIG. 8 and blocks 912 and 918 of FIG. 9. In some examples, the actuator control circuitry 702 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the actuator control circuitry 702 may be instantiated by any other combination of hardware, software, and/or firmware. For example, the actuator control circuitry 702 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the speed detection circuitry 704 is instantiated by programmable circuitry executing speed detection instructions and/or configured to perform operations such as those represented by the flowchart of FIG. 8.

In some examples, the hinge management circuitry 700 includes means for determining a hard closure. For example, the means for determining a hard closure may be implemented by speed detection circuitry 704. In some examples, the speed detection circuitry 704 may be instantiated by programmable circuitry such as the example programmable circuitry 1012 of FIG. 10. For instance, the speed detection circuitry 704 may be instantiated by the example microprocessor 1100 of FIG. 11 executing machine executable instructions such as those implemented by at least blocks 806, 808, 816, 818, 820, and 824, of FIG. 8. In some examples, the speed detection circuitry 704 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the speed detection circuitry 704 may be instantiated by any other combination of hardware, software, and/or firmware. For example, the speed detection circuitry 704 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the object detection circuitry 706 is instantiated by programmable circuitry executing object detection instructions and/or configured to perform operations such as those represented by the flowchart of FIG. 9.

In some examples, the hinge management circuitry 700 includes means for detecting an object. For example, the means for detecting an object may be implemented by object detection circuitry 706. In some examples, the object detection circuitry 706 may be instantiated by programmable circuitry such as the example programmable circuitry 1012 of FIG. 10. For instance, the object detection circuitry 706 may be instantiated by the example microprocessor 1100 of FIG. 11 executing machine executable instructions such as those implemented by at least blocks 906, 908 and 916 of FIG. 9. In some examples, the object detection circuitry 706 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the object detection circuitry 706 may be instantiated by any other combination of hardware, software, and/or firmware. For example, the object detection circuitry 706 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the hinge lock threshold circuitry 708 is instantiated by programmable circuitry executing hinge lock threshold instructions and/or configured to perform operations such as those represented by the flowcharts of FIGS. 8-9.

In some examples, the hinge management circuitry 700 includes means for comparing values. For example, the means for comparing values may be implemented by hinge lock threshold circuitry 708. In some examples, the hinge lock threshold circuitry 708 may be instantiated by programmable circuitry such as the example programmable circuitry 1012 of FIG. 10. For instance, the hinge lock threshold circuitry 708 may be instantiated by the example microprocessor 1100 of FIG. 11 executing machine executable instructions such as those implemented by at least blocks 802, 804, and 810 of FIG. 8 and blocks 902, 904, 910 of FIG. 9. In some examples, the hinge lock threshold circuitry 708 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the hinge lock threshold circuitry 708 may be instantiated by any other combination of hardware, software, and/or firmware. For example, the hinge lock threshold circuitry 708 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the notification circuitry 710 is instantiated by programmable circuitry executing notification instructions and/or configured to perform operations such as those represented by the flowcharts of FIGS. 8-9.

In some examples, the hinge management circuitry 700 includes means for notifying users. For example, the means for notifying users may be implemented by notification circuitry 710. In some examples, the notification circuitry 710 may be instantiated by programmable circuitry such as the example programmable circuitry 1012 of FIG. 10. For instance, the notification circuitry 710 may be instantiated by the example microprocessor 1100 of FIG. 11 executing machine executable instructions such as those implemented by at least block 814 of FIG. 8 and block 914 of FIG. 9. In some examples, the notification circuitry 710 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the notification circuitry 710 may be instantiated by any other combination of hardware, software, and/or firmware. For example, the notification circuitry 710 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the device mode circuitry 712 is instantiated by programmable circuitry executing device mode instructions and/or configured to perform operations such as those represented by the flowchart of FIG. 8.

In some examples, the hinge management circuitry 700 includes means for activating a device mode. For example, the means for activating a device mode may be implemented by device mode circuitry 712. In some examples, the device mode circuitry 712 may be instantiated by programmable circuitry such as the example programmable circuitry 1012 of FIG. 10. For instance, the device mode circuitry 712 may be instantiated by the example microprocessor 1100 of FIG. 11 executing machine executable instructions such as those implemented by at least blocks 816, 818, 820, 822, and 824 of FIG. 8. In some examples, the device mode circuitry 712 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the device mode circuitry 712 may be instantiated by any other combination of hardware, software, and/or firmware. For example, the device mode circuitry 712 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the hinge management circuitry 700 of FIG. 1 is illustrated in FIG. 7, one or more of the elements, processes, and/or devices illustrated in FIG. 7 may be combined, divided, re-arranged, omitted, eliminated, and/or implemented in any other way. Further, the example actuator control circuitry 702, the example speed detection circuitry 704, the example object detection circuitry 706, the example hinge lock threshold circuitry 708, the example notification circuitry 710, and the example device mode circuitry 712, and/or, more generally, the example hinge management circuitry 700 of FIG. 7, may be implemented by hardware alone or by hardware in combination with software and/or firmware. Thus, for example, any of the example actuator control circuitry 702, the example speed detection circuitry 704, the example object detection circuitry 706, the example hinge lock threshold circuitry 708, the example notification circuitry 710, and the example device mode circuitry 712, and/or, more generally, the example hinge management circuitry 700, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example hinge management circuitry 700 of FIG. 7 may include one or more elements, processes, and/or devices in addition to, or instead of, those illustrated in FIG. 7, and/or may include more than one of any or all of the illustrated elements, processes and devices.

Flowchart(s) representative of example machine readable instructions, which may be executed by programmable circuitry to implement and/or instantiate the hinge management circuitry 700 of FIG. 7 and/or representative of example operations which may be performed by programmable circuitry to implement and/or instantiate the hinge management circuitry 700 of FIG. 7, are shown in FIGS. 8-9. The machine readable instructions may be one or more executable programs or portion(s) of one or more executable programs for execution by programmable circuitry such as the programmable circuitry 1012 shown in the example programmable circuitry platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8-9, many other methods of implementing the example hinge management circuitry 700 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to implement the example hinge management circuitry 700 of FIG. 7 to detect a closing speed and/or velocity. The example machine-readable instructions and/or the example operations 800 of FIG. 8 begin at block 802, at which the example hinge lock threshold circuitry 708 detects lid movement. In some examples, the hinge lock threshold circuitry 708 receives one or more feedback signals from a rotary encoder to determine a rotational direction of the first housing 102 relative to the second housing 104.

At block 804, the example hinge lock threshold circuitry 708 determines if the lid angle is decreasing (e.g., a rate of lid angle reduction). For example, in response to the hinge lock threshold circuitry 708 determining that the lid angle is decreasing (e.g., “YES”), control advances to block 806. Alternatively, in response to the hinge lock threshold circuitry 708 determining that the lid angle is not decreasing (e.g., “NO”), control returns to block 802. In some examples, the hinge lock threshold circuitry 708 is to determine the lid angle is decreasing by determining if a subsequent lid angle (e.g., seventy degrees) is smaller than a previous lid angle (e.g., eighty degrees) based on feedback signals received from one or more sensors of the electronic device 100.

At block 806, the example speed detection circuitry 704 determines if a hard closure is projected (e.g., imminent). For example, the speed detection circuitry 704 may determine a hard closure detected based on the speed of the first housing 102 (FIG. 1). For example, the speed detection circuitry 704 may determine a hard closure is imminent if the closing speed of the first housing 102 (FIG. 1) exceeds a speed threshold (e.g., from a look-up table) and/or a calculated force exceeds a force threshold (e.g., from a look-up table).

At block 808, the example speed detection circuitry 704 detects a hard closure. For example, in response to the speed detection circuitry 704 determining that a hard closure is detected (e.g., “YES”), control advances to block 810. Alternatively, in response to the speed detection circuitry 704 determining that a hard closure is not detected (e.g., “NO”), control returns to block 804.

At block 810, the example hinge lock threshold circuitry 708 determines if the lid angle exceeds an angle threshold. For example, in response to the hinge lock threshold circuitry 708 determining the lid angle exceeds angle threshold (e.g., “YES”), control returns to block 804. Alternatively, in response to the hinge lock threshold circuitry 708 determining the lid angle does not exceed threshold angle (e.g., “NO”), control advances to block 812. For example, the hinge lock threshold circuitry 708 can determine, obtain, or otherwise retrieve the angle threshold (e.g., a minimum allowable angle, an angle value, etc. from a look-up table or memory). In such examples, if the lid angle is less than the angle threshold (e.g., 5 degrees), then the actuator control circuitry 702 activates of the hinge lock apparatus 200 (e.g., the activated condition 400).

At block 812, the example actuator control circuitry 702 activates the hinge lock apparatus 200. For example, the actuator control circuitry 702 may cause the actuator 204 to move to the extended position 204B to cause the actuator plunger 224 (FIG. 2B) to move into the receptacle 202a (FIG. 2A) to restrict or prevent rotation of the shaft 206 about the longitudinal axis 218. Control advances to block 814.

At block 814, the example notification circuitry 710 notifies the user that the hinge lock apparatus 200 is activated. For example, the notification circuitry 710 may alert the user via an auditory message or a visual message on a display 112 (FIG. 1) that the hinge lock apparatus 200 is in the activated condition 400. Control returns to block 802.

At block 816, the example speed detection circuitry 704 and/or the device mode circuitry 712 determines if a user input is detected. For example, a user can input a command via the input (e.g., activated or selected by a user via the keyboard 108, track pad 110, the display 112, voice command, etc.) to activate hinge lock mode 126. If at block 816 a user input is not detected (e.g., “NO”), then the control returns to block 802 (e.g., with the hinge lock apparatus 200 in the activated condition 400). If at block 816 a user input is detected (e.g., “YES”), then control proceeds to block 818.

At block 818 (after block 816), the example speed detection circuitry 704 and/or the device mode circuitry 712 determines if the user input at block 816 is to deactivate the hinge lock apparatus 200. If at block 818 the detected user input is not to deactivate the hinge lock apparatus 200 (e.g., “NO”), then control returns to block 812. If at block 818 the detected user input is to deactivate the hinge lock apparatus 200 (e.g., “YES”), control proceeds to block 820.

At block 820, the example actuator control circuitry 702, the example speed detection circuitry 704 and/or the device mode circuitry 712 instruct, command and/or otherwise the cause the actuator 204 to move to the retracted position 204A and move the hinge lock apparatus 200 to the unlocked position 300, control then proceeds to block 802.

Returning to block 804, if the speed detection circuitry 704 does not detect that the lid angle is decreasing at block 804 (e.g., “NO”), control proceeds to block 822.

At block 822, the example device mode circuitry 712 determines an operational mode (e.g., high-performance mode, game mode, etc.) and/or a configuration mode (e.g., tablet configuration, kiosk configuration, tent configuration, etc.) via feedback signals and/or user inputs. In response to the device mode circuitry 712 detecting the electronic device 100 in an operational mode and/or configuration at block 822 (e.g., “YES”), control proceeds to block 812 (e.g., the device mode circuitry 712 and/or actuator control circuitry 702 causes activation of the hinge lock apparatus 200) (e.g., the activated condition 400). In response to determining that the electronic device 100 is not in an operational mode and/or configuration (e.g., “NO”), control proceeds to block 824.

At block 824, the example speed detection circuitry 704 and/or the device mode circuitry 712 determines if a user input is detected. For example, a user can input a command via the input (e.g., activated or selected by a user via the keyboard 108, track pad 110, the display 112, voice command, etc.) to activate hinge lock mode 126. If at block 824 a user input is not detected (e.g., “NO”), then control returns to block 820, where the example actuator control circuitry 702, the example speed detection circuitry 704 and/or the device mode circuitry 712 instruct, command and/or otherwise the cause the actuator 204 to move to the retracted position 204A and move the hinge lock apparatus 200 to the unlocked condition 300. The control then proceeds to block 802. In response to detecting a user input at block 824, control proceeds to block 818.

At block 818 (after block 824), the example speed detection circuitry 704 and/or the device mode circuitry 712 determines if a user input is detected. For example, a user can input a command via the input to activate hinge lock mode 126. If at block 818 a user input is not detected (e.g., “NO”), then control returns to block 812, where the actuator control circuitry 702 causes activation of the hinge lock apparatus 200 (e.g., moves the hinge lock apparatus 200 in the activated condition 400). If at block 818 a user input to deactivate the hinge lock apparatus 200 is detected (e.g., “YES”), then control proceeds to block 820, where the hinge lock apparatus 200 is moved to the unlocked position 300 (e.g., the actuator 204 is moved to the retracted position 204A). Control then proceeds to block 802. In some examples, the instructions end after block 818. In some examples, the instructions end after block 816. In such examples, after the instructions 800 end, the instructions can be re-executed.

FIG. 9 is a flowchart representative of example machine readable instructions and/or example operations 900 that may be executed, instantiated, and/or performed by programmable circuitry to implement the example hinge management circuitry 700 of FIG. 7 to detect an object. The example machine-readable instructions and/or the example operations 900 of FIG. 9 begin at block 902, at which the example hinge lock threshold circuitry 708 detects lid movement. For example, the hinge lock threshold circuitry 708 may detect lid movement by comparing a position of the first housing 102 (FIG. 1) and a reference position. If the position is different, the example hinge lock threshold circuitry 708 may determine that the lid is moving.

At block 904, the example hinge lock threshold circuitry 708 determines if the lid angle is decreasing. For example, in response to the hinge lock threshold circuitry 708 determining that the lid angle is decreasing (e.g., “YES”), control advances to block 906. Alternatively, in response to the hinge lock threshold circuitry 708 determining that the lid angle is not decreasing (e.g., “NO”), control returns to block 902. In some examples, the hinge lock threshold circuitry 708 is to determine the lid angle is decreasing by determining if the subsequent lid angle (e.g., seventy degrees) is smaller than a previous lid angle (e.g., eighty degrees).

At block 906, the example object detection circuitry 706 determines if an object is on the cover. For example, the object detection circuitry 706 determines if the example object 130 (FIG. 1) is on the second housing 104 (FIG. 1).

At block 908, the example object detection circuitry 706 determines that the object is detected. For example, in response to the object detection circuitry 706 determining that an object is detected (e.g., “YES”), control advances to block 910.

Alternatively, in response to the object detection circuitry 706 determining that an object is not detected (e.g., “NO”), control returns to block 902. For example, the object detection circuitry 706 may determine that an object is detected or not detected based on an ultrasound mapping of the second housing 104 (FIG. 1).

At block 910, the example hinge lock threshold circuitry 708 determines if the lid angle exceeds a threshold angle. For example, in response to the hinge lock threshold circuitry 708 determining the lid angle exceeds threshold angle (e.g., “YES”), control returns to block 904. Alternatively, in response to the hinge lock threshold circuitry 708 determining the lid angle does not exceed threshold angle (e.g., “NO”), control advances to block 912. For example, the hinge lock threshold circuitry 708 may determine that the threshold angle is a minimum angle. In such examples, where the threshold angle is a minimum angle, if the lid angle drops below the minimum angle, then the actuator control circuitry 702 activates the hinge lock.

At block 912, the example actuator control circuitry 702 activates the hinge lock. For example, the actuator control circuitry 702 may cause the actuator 204 (FIG. 2B) to move into the receptacle 202a (FIG. 2A) which restricts the hinge 106 (FIG. 1).

At block 914, the example notification circuitry 710 notifies the user that the hinge lock is activated. For example, the notification circuitry 710 may alert the user via an auditory message or a visual message on a display 112 (FIG. 1).

At block 916, the example object detection circuitry 706 determines if the object is still present. For example, in response to the object detection circuitry 706 determining that an object is detected (e.g., “YES”), control advances to block 906 (e.g., with the hinge lock apparatus 200 in the activated condition 400). Alternatively, in response to the object detection circuitry 706 determining that an object is not detected (e.g., “NO”), control advances to block 918.

At block 918, the actuator control circuitry 702 or the object detection circuitry causes the actuator 204 to actuate to the extended position 204B to move the hinge lock apparatus 200 in the unlocked position 300 (e.g., deactivated condition). The instructions 900 end.

FIG. 10 is a block diagram of an example programmable circuitry platform 1000 structured to execute and/or instantiate the example machine-readable instructions and/or the example operations of FIGS. 8-9 to implement the hinge management circuitry 700 of FIG. 7. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example actuator control circuitry 702, the example speed detection circuitry 704, the example object detection circuitry 706, the example hinge lock threshold circuitry 708, the example notification circuitry 710, and the example device mode circuitry 712.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 8-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 8-9 to effectively instantiate the circuitry of FIG. 7 as logic circuits to perform operations corresponding to those machine readable instructions. In some such examples, the circuitry of FIG. 7 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 8-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 8-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8-9. As such, the FPGA circuitry 1200 may be configured and/or structured to effectively instantiate some or all of the operations/functions corresponding to the machine readable instructions of the flowchart(s) of FIGS. 8-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 8-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 8-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 8-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIG. 8-9, and/or an ASIC may be configured and/or structured to perform third operation(s)/function(s) corresponding to a third portion of the machine readable instructions represented by the flowcharts of FIGS. 8-9.

It should be understood that some or all of the circuitry of FIG. 7 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 7 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 7 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

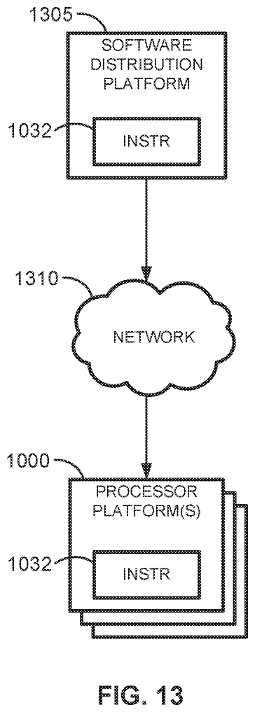

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 8-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIG. 8-9, may be downloaded to the example programmable circuitry platform 1000, which is to execute the machine readable instructions 1032 to implement the hinge management circuitry 700. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to lock a hinge of an electronic device are disclosed herein. Further examples and combinations thereof include the following:

Example 1 includes a system including a first housing, a second housing, and a hinge to pivotally couple the first housing and the second housing. The hinge includes a hinge lock apparatus having a lock interface and an actuator movable relative to the lock interface between a first position to engage the lock interface to at least one of prevent or restrict rotation of the first housing relative to the second housing, and a second position to disengage the lock interface to enable rotation of the first housing relative to the second housing. Processor circuitry operates the actuator based on a detected condition of the first housing relative to the second housing.

Example 2 includes the system of example 1, where the hinge includes a shaft, and where the lock interface includes a gear fixed to the shaft such that the gear rotates with the shaft about an axis of rotation of the hinge.

Example 3 includes the system of any one of examples 1-2, wherein a longitudinal axis of the gear coaxially aligned a longitudinal axis of the shaft, and a longitudinal axis of the gear is non-parallel relative to a longitudinal axis of the actuator.

Example 4 includes the system of any one of examples 1-3, where the gear includes a barrel having external threads, the shaft has an end that includes an opening having internal threads, the external threads of the barrel threadably couple with the internal threads of the opening to couple the gear and the shaft.

Example 5 includes the system of any one of examples 1-4, where the actuator includes a plunger that moves between the first position to engage the lock interface and the second position to disengage lock interface the based on an electrical signal generated by the processor circuitry in response to the detected condition.

Example 6 includes the system of any one of examples 1-5, where the lock interface is a gear having a plurality of gear teeth, the plunger of the actuator having a shape complementary to a shape of the gear teeth.

Example 7 includes the system of any one of examples 1-6, where the lock interface is a gear having a plurality of gear teeth, and where the plunger is to enmesh with the gear teeth when the actuator is in the first position.

Example 8 includes the system of any one of examples 1-7 where the lock interface and the actuator are carried by the second housing.

Example 9 includes the system of any one of examples 1-8, where the processor circuitry is to detect a presence or absence of an object on an upper surface of the second housing.

Example 10 includes the system of any one of examples 1-9, where the processor circuitry is to cause the actuator to move to the first position in response to detecting the presence of the object on the second housing and an angular position of the first housing below an angle threshold.

Example 11 includes the system of any one of examples 1-10, where the processor circuitry is to detect a rate of reduction of a lid angle when the first housing rotates toward the second housing.

Example 12 includes the system of any one of examples 1-11, where the processor circuitry is to at least one of detect a closing speed or a force of the first housing in response to the processor circuitry detecting the rate of reduction of the lid angle when the first housing moves toward the second housing.

Example 13 includes the system of any one of examples 1-12, where the processor circuitry is to cause the actuator to move to the second position to enable rotation of the first housing relative to the second housing in response to determining that the detected closing speed below a speed threshold.

Example 14 includes the system of any one of examples 1-13, where the processor circuitry is to cause the actuator to move to the second position to prevent an angular position of the first housing from reducing less than an angle threshold needed to allow heat dissipation via vents on an upper surface of the second housing.

Example 15 includes a non-transitory machine readable storage medium including instructions to cause programmable circuitry to at least: detect a rotational direction of a first housing, in response to detecting that the first housing is rotational toward a second housing, detect at least one of a closing speed of the first housing or a presence of an object on an upper surface of the second housing, and operate an actuator based on at least one of a detected object on the upper surface of the second housing or the detected closing speed exceeding a speed threshold, the actuator movable between a first position to engage a receptacle carried by a hinge pivotally coupling the first housing and the second housing to at least one of restrict or prevent rotation of the first housing relative to the second housing in response to detecting the at least one of the object on the upper surface or the detected closing speed exceeding the speed threshold, and a second position to disengage the receptable to enable rotation of the first housing relative to the second housing in response to determining at least one of an absence of the object on the upper surface of the second housing or the detected closing speed below the speed threshold.

Example 16 includes the non-transitory machine readable storage medium of example 15, where the programmable circuitry is to detect a high-performance mode of an electronic device, the programmable circuitry is to activate the actuator to the first position to prevent rotation of the first housing relative to the second housing in response to detecting that the electronic device is in the high-performance mode and an angular position of the first housing relative to the second housing below an angle threshold.

Example 17 includes the non-transitory machine readable storage medium of examples 15 or 16, wherein the programmable circuitry is to cause the actuator to move between the first position and the second position based on a user input.

Example 18 includes a method for operating an electronic device, the method including detecting, by executing an instruction with a processor, an object on a first housing. The method includes detecting, by executing an instruction with a processor, a rotational direction of a first housing, in response to detecting that the first housing is rotational toward a second housing. The method further includes detecting, by executing an instruction with a processor, at least one of a closing speed of the first housing or a presence of an object on an upper surface of the second housing, and operating, by executing an instruction with a processor, an actuator based on at least one of a detected object on the upper surface of the second housing or the detected closing speed exceeding a speed threshold, where operating the actuator is to cause the actuator to move between a first position to engage a receptacle carried by a hinge pivotally coupling the first housing and the second housing to at least one of restrict or prevent rotation of the first housing relative to the second housing in response to detecting the at least one of the object on the upper surface or the detected closing speed exceeding the speed threshold, and a second position to disengage the receptable to enable rotation of the first housing relative to the second housing in response to determining at least one of an absence of the object on the upper surface of the second housing or the detected closing speed below the speed threshold.

Example 19 includes the method of example 18, further including detecting a high-performance mode of the electronic device, detecting an angular position of the first housing relative to the second housing, and operating the actuator to the first position to prevent rotation of the first housing relative to the second housing in response to detecting that the electronic device is in the high-performance mode and the angular position below an angle threshold.

Example 20 includes the method of any one of examples 18 or 19, further including operating the actuator to move between the first position and the second position based on a user input.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
a first housing;
a second housing;
a hinge to pivotally couple the first housing and the second housing, the hinge including a hinge lock apparatus having;
a lock interface;
an actuator movable relative to the lock interface between:
a first position to engage the lock interface to at least one of prevent or restrict rotation of the first housing relative to the second housing; and
a second position to disengage the lock interface to enable rotation of the first housing relative to the second housing; and
processor circuitry to operate the actuator based on a detected condition of the first housing relative to the second housing.

2. The system of claim 1, wherein the hinge includes a shaft, and wherein the lock interface includes a gear fixed to the shaft such that the gear rotates with the shaft about an axis of rotation of the hinge.

3. The system of claim 2, wherein a longitudinal axis of the gear coaxially aligned a longitudinal axis of the shaft, and a longitudinal axis of the gear is non-parallel relative to a longitudinal axis of the actuator.

4. The system of claim 2, wherein the gear includes a barrel having external threads, the shaft having an end that includes an opening having internal threads, the external threads of the barrel threadably couple with the internal threads of the opening to couple the gear and the shaft.

5. The system of claim 1, wherein the actuator includes a plunger that moves between the first position to engage the lock interface and the second position to disengage the lock interface based on an electrical signal generated by the processor circuitry in response to the detected condition.

6. The system of claim 5, wherein the lock interface is a gear having a plurality of gear teeth, the plunger of the actuator having a shape complementary to a shape of the gear teeth.

7. The system of claim 5, wherein the lock interface is a gear having a plurality of gear teeth, wherein the plunger is to enmesh with the gear teeth when the actuator is in the first position.

8. The system of claim 1 wherein the lock interface and the actuator are carried by the second housing.

9. The system of claim 1, wherein the processor circuitry is to detect a presence or absence of an object on an upper surface of the second housing.

10. The system of claim 9, wherein the processor circuitry is to cause the actuator to move to the first position in response to detecting the presence of the object on the second housing and an angular position of the first housing below an angle threshold.

11. The system of claim 1, wherein the processor circuitry is to detect a rate of reduction of a lid angle when the first housing rotates toward the second housing.

12. The system of claim 11, wherein the processor circuitry is to at least one of detect a closing speed or a force of the first housing in response to the processor circuitry detecting the rate of reduction of the lid angle when the first housing moves toward the second housing.

13. The system of claim 12, wherein the processor circuitry is to cause the actuator to move to the second position to enable rotation of the first housing relative to the second housing in response to determining that the detected closing speed below a speed threshold.

14. The system of claim 1, wherein the processor circuitry is to cause the actuator to move to the second position to prevent an angular position of the first housing from reducing less than an angle threshold needed to allow heat dissipation via vents on an upper surface of the second housing.

15. A non-transitory machine readable storage medium comprising instructions to cause programmable circuitry to at least:
detect a rotational direction of a first housing;
in response to detecting that the first housing is rotational toward a second housing, detect at least one of a closing speed of the first housing or a presence of an object on an upper surface of the second housing; and
operate an actuator based on at least one of a detected object on the upper surface of the second housing or the detected closing speed exceeding a speed threshold, the actuator movable between:
a first position to engage a receptacle carried by a hinge pivotally coupling the first housing and the second housing to at least one of restrict or prevent rotation of the first housing relative to the second housing in response to detecting the at least one of the object on the upper surface or the detected closing speed exceeding the speed threshold; and
a second position to disengage the receptable to enable rotation of the first housing relative to the second housing in response to determining at least one of an absence of the object on the upper surface of the second housing or the detected closing speed below the speed threshold.

16. The non-transitory machine readable storage medium of claim 15, wherein the programmable circuitry is to detect a high-performance mode of an electronic device, the programmable circuitry is to activate the actuator to the first position to prevent rotation of the first housing relative to the second housing in response to detecting that the electronic device is in the high-performance mode and an angular position of the first housing relative to the second housing below an angle threshold.

17. The non-transitory machine readable storage medium of claim 15, wherein the programmable circuitry is to cause the actuator to move between the first position and the second position based on a user input.

18. A method for operating an electronic device, the method comprising:
detecting, by executing an instruction with a processor, an object on a first housing;
detecting, by executing an instruction with a processor, a rotational direction of a first housing;
in response to detecting that the first housing is rotational toward a second housing, detecting, by executing an instruction with a processor, at least one of a closing speed of the first housing or a presence of an object on an upper surface of the second housing; and
operating, by executing an instruction with a processor, an actuator based on at least one of a detected object on the upper surface of the second housing or the detected closing speed exceeding a speed threshold, wherein operating the actuator is to cause the actuator to move between:
a first position to engage a receptacle carried by a hinge pivotally coupling the first housing and the second housing to at least one of restrict or prevent rotation of the first housing relative to the second housing in response to detecting the at least one of the object on the upper surface or the detected closing speed exceeding the speed threshold; and
a second position to disengage the receptable to enable rotation of the first housing relative to the second housing in response to determining at least one of an absence of the object on the upper surface of the second housing or the detected closing speed below the speed threshold.

19. The method of claim 18, further including:
detecting a high-performance mode of the electronic device;
detecting an angular position of the first housing relative to the second housing; and
operating the actuator to the first position to prevent rotation of the first housing relative to the second housing in response to detecting that the electronic device is in the high-performance mode and the angular position below an angle threshold.

20. The method of claim 18, further including operating the actuator to move between the first position and the second position based on a user input.
